(19) United States
(12) Patent Application Publication
(10) Pub. No.: US 2015/0053297 A1
(43) Pub. Date: Feb. 26, 2015

(54) CONTAINER WAND ASSEMBLY

(71) Applicant: Parker-Hannifin Corporation, Cleveland, OH (US)

(72) Inventor: Donald Gembolis, Toledo, OH (US)

(21) Appl. No.: 14/388,530

(22) PCT Filed: Apr. 2, 2013
(86) PCT No.: PCT/US2013/034975

§ 371 Date: Sep. 26, 2014

Related U.S. Application Data
(60) Provisional application No. 61/619,090, filed on Apr. 2, 2012.

(51) Int. Cl. F16L 9/18

(52) U.S. Cl. CPC F16L 9/18
USPC 138/114

(57) ABSTRACT

Provided is a recirculation device, such as a wand, including an inner tube having a suction inlet through which fluid enters the inner tube and a suction outlet through which fluid exits the inner tube, and an outer tube at least partially surrounding the inner tube and forming therebetween a second fluid passage, the outer tube including a return inlet through which fluid enters the second fluid passage, and at least one return outlet through which fluid exits the second fluid passage. The recirculation device eliminates the need for separate suction and return wands and additionally or alternatively eliminates or minimizes direct recirculation of return fluid reintroduced into the reservoir through a suction inlet.

### RELATED APPLICATIONS

This application claims the benefit of U.S. Provisional Application No. 61/619,090 filed Apr. 2, 2012, which is hereby incorporated herein by reference.

### FIELD OF INVENTION

The present invention relates generally to fluid recirculation, and more particularly to a wand for recirculating fluid in an assembly.

### BACKGROUND

Fluids such as hydraulic fluids generally have a high initial contamination level that is added to the fluid during processing, mixing, handling and storing of the fluid. To remove the initial contamination and contamination that builds up in the fluid in a fluid container, such as a reservoir, over time, fluid filter carts may be provided to clean the fluid in the reservoir of a hydraulic system and/or transfer fluids to/from the filter cart from/to the hydraulic system. For example, the filter carts may be portable filter carts utilized to remove water and contaminants from the hydraulic fluid in the hydraulic system reservoir. The portable filter carts include a pump, a filter, a suction wand, and a return wand, which wands are inserted into the reservoir from above.

### SUMMARY OF INVENTION

The present invention provides a recirculation device, such as a wand, including an inner tube having a suction inlet through which fluid enters the inner tube and a suction outlet through which fluid exits the inner tube, and an outer tube at least partially surrounding the inner tube and forming therebetween a second fluid passage, the outer tube including a return inlet through which fluid enters the second fluid passage, and at least one return outlet through which fluid exits the second fluid passage. The recirculation device eliminates the need for separate suction and return wands and additionally or alternatively eliminates or minimizes direct recirculation of return fluid reintroduced into the reservoir through a suction inlet.

According to one aspect of the invention, a recirculation device for recirculating fluid within a system is provided. The device includes an inner tube having a suction inlet at a first end through which fluid enters the inner tube, a suction outlet at a second end through which fluid exits the inner tube, and a first fluid passage extending therebetween, and an outer tube at least partially surrounding the inner tube and forming therebetween a second fluid passage, the outer tube including first and second ends, a return inlet through which fluid enters the second fluid passage, and at least one return outlet adjacent the first end of the outer tube through which fluid exits the second fluid passage.

The at least one return outlet directs the fluid in a direction laterally away from the inner tube.

The at least one return outlet includes a plurality of return outlets circumferentially spaced around the outer tube.

The return inlet extends through a wall of the outer tube adjacent the second end of the outer tube and the at least one return inlet extends through the wall adjacent the first end of the outer tube.

The at least one return outlet is spaced from the suction inlet a sufficient distance to prevent, when in use in a reservoir containing fluid in which the return outlet of the outer tube is immersed, recirculation of the fluid from the return outlet to the suction inlet during a period of approximately thirty seconds.

The at least one return outlet is spaced from the suction inlet a distance at least six times the diameter of the inner tube to prevent direct recirculation of the fluid from the return outlet to the suction inlet.

The inner and outer tubes are concentric.

The return inlet is adjacent a second end of the outer tube.

The outer tube is coupled to the inner tube at the second end of the outer tube by welding or brazing.

The outer tube is coupled to the inner tube at the first and second ends by welding or brazing.

The outer tube is sealed to the inner tube at the second end.

The outer tube includes a seal disposed in a seal groove in the outer tube to seal the outer tube to the inner tube.

The outer tube is axially movable relative to the inner tube along a length of the inner tube.

The first end has a face that is offset from an axis of the inner tube.

The face is offset at a forty-five degree angle.

According to another aspect of the invention, a recirculation device for recirculating fluid within a system is provided, the device including an inner tube having a suction inlet at a first end, a suction outlet at a second end, and a first fluid passage extending therebetween, and an outer tube surrounding the inner tube and including a return inlet through a wall of the outer tube adjacent a second end of the outer tube and at least one return outlet through the wall adjacent a first end of the outer tube, wherein a second fluid passage from the return inlet to at least one return outlet is formed between the wall of the outer tube and a wall of the inner tube.

The at least one return outlet directs the fluid in a direction laterally away from the inner tube.

The at least one return outlet includes a plurality of return outlets circumferentially spaced around the outer tube.

The at least one return outlet is spaced from the suction inlet a sufficient distance to prevent, when in use in a reservoir containing fluid in which the return outlet of the outer tube is immersed, recirculation of the fluid from the return outlet to the suction inlet during a period of approximately thirty seconds.

The at least one return outlet is spaced from the suction inlet a distance at least six times the diameter of the inner tube to prevent direct recirculation of the fluid from the return outlet to the suction inlet.

The distance is at least twelve times the diameter of the inner tube.

The inner and outer tubes are concentric.

The outer tube is coupled to the inner tube at the second end of the outer tube by welding or brazing.

The outer tube is coupled to the inner tube at the first and second ends by welding or brazing.

The outer tube includes a seal disposed in a seal groove in the outer tube to seal the outer tube to the inner tube.

The outer tube is axially movable relative to the inner tube along a length of the inner tube.

The first end has a face that is offset from an axis of the inner tube.

The face is offset at a forty-five degree angle.

According to still another aspect of the invention, a portable filter cart is provided that includes a recirculation wand including an inner tube having a suction inlet at a first end through which fluid enters the inner tube, a suction outlet at a second end through which fluid exits the inner tube, and a first fluid passage extending therebetween, and an outer tube at least partially surrounding the inner tube and forming therebetween a second fluid passage, the outer tube including first and second ends, a return inlet through which fluid enters the second fluid passage, and at least one return outlet adjacent the first end of the outer tube through which fluid exits the second fluid passage, and a pump having an inlet coupled to the suction outlet and an outlet coupled to the return inlet.

The portable filter cart further includes a filter coupled to one of inlet or outlet of the pump for removing contaminants from the fluid.

The inner and outer tubes are concentric.

According to a further aspect of the invention, a method of filtering hydraulic fluid in a reservoir is provided, the method including drawing fluid into an inner tube of a recirculation wand, delivering the fluid from the inner tube to a filter, filtering contaminants from the fluid, delivering the fluid from the filter to a flow path between the inner tube and an outer tube of the recirculation wand surrounding the inner tube, and directing the fluid from the flow path into the reservoir in a direction laterally away from the inner tube.

The foregoing and other features of the invention are hereinafter described in greater detail with reference to the accompanying drawings.

### BRIEF DESCRIPTION OF THE DRAWINGS

FIG. 1 is a schematic illustration a reservoir for a hydraulic component in communication with a fluid processing device;

FIG. 2 is a perspective view of an exemplary recirculation device according to the invention;

FIG. 3 is a top view of the recirculation device;

FIG. 4 is a cross-sectional view of the recirculation device taken substantially along line A-A in FIG. 3;

FIG. 5 is a cross-sectional view of another exemplary recirculation device according to the invention; and

FIG. 6 is a cross-sectional view of still another exemplary recirculation device according to the invention.

### DETAILED DESCRIPTION

The principles of the present invention have particular application to recirculation wands for removing contaminants and water from hydraulic fluid at a bottom of a hydraulic fluid reservoir and thus will be described below chiefly in this context. It will of course be appreciated, and also understood, that the principles of the invention may be useful with suitable fluids such as hydraulic fluid, gear oil, lube oils, etc., in other applications including filtering new fluid before putting the fluid into service, transferring fluid from storage containers to system reservoirs, complimenting existing system filtration, and vacuum dehydration.

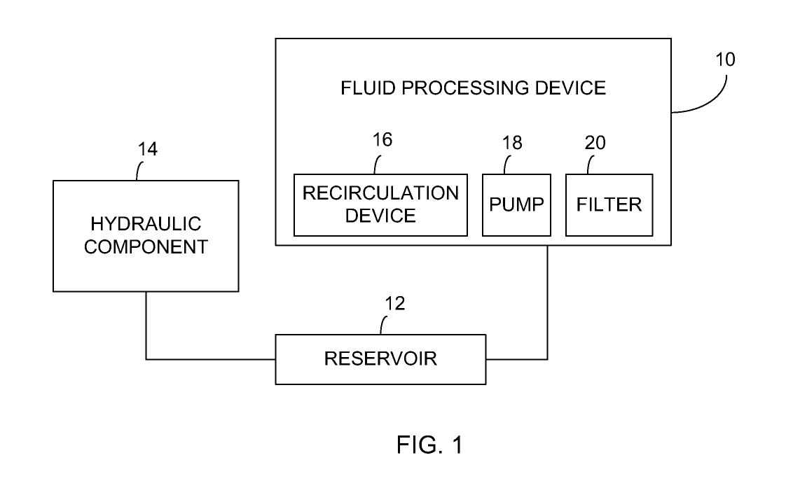

Turning now to FIG. 1, a fluid processing device 10 is shown in communication with a reservoir 12 for a hydraulic component 14. The reservoir 12 may be any suitable reservoir, such as a sixty gallon reservoir, and the hydraulic component may be any suitable hydraulic component, such as a hydraulic crane. The fluid processing device 10, which may be a portable cart, such as a portable filter cart, may include a frame having tires provided at a bottom portion, a cabinet for replacement elements, a retractable power cord, and flow meter.

The portable filter cart 10 also includes a recirculation device 16, such as a wand that provides for suction and return, a pump 18 for pumping the fluid into and out of the wand, and a filter 20 for filtering contaminants and/or water from the fluid. The pump 18 and filter 20 may be any suitable pump and filter, such as a variable flow pump and a high efficiency filter. The pump 18 and filter 20 are coupled to the recirculation device 16 such that fluid is drawn from the reservoir 12 into the recirculation device by the pump 18, passed through the filter 20, and then pumped back into the reservoir 12.

When there is limited access to the reservoir 12, such as when the reservoir 12 includes only one access port, such as a two inch fitting, the recirculation device 16 can be introduced into the access port to eliminate the need for a suction wand for sucking the fluid into the wand and a separate return wand for returning the fluid to the reservoir 12. The recirculation device 16 also provides for increased fluid agitation to create cross flow within the reservoir 12. It will also be appreciated that the portable filter cart 10 may include, in addition to the recirculation device 16 that provides for both suction and return of the hydraulic fluid, a separate return wand that may be used for transferring filtered hydraulic fluid from storage containers to the hydraulic component 14 and/or reservoir 12.

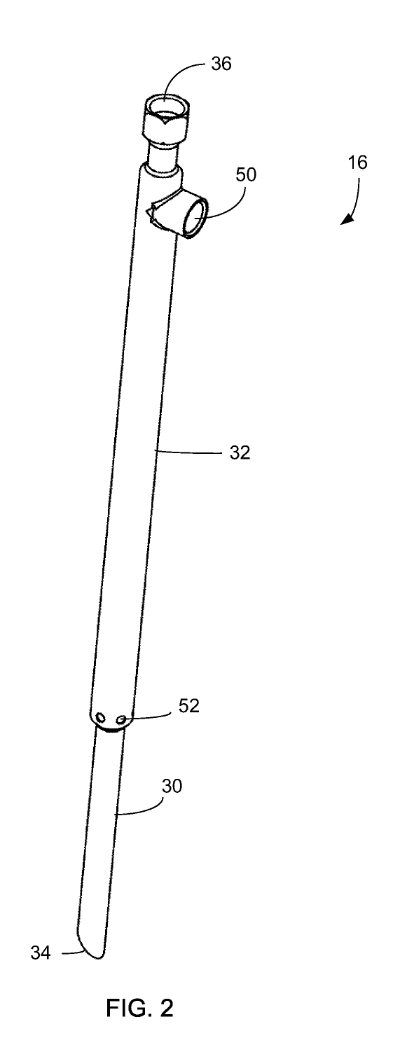

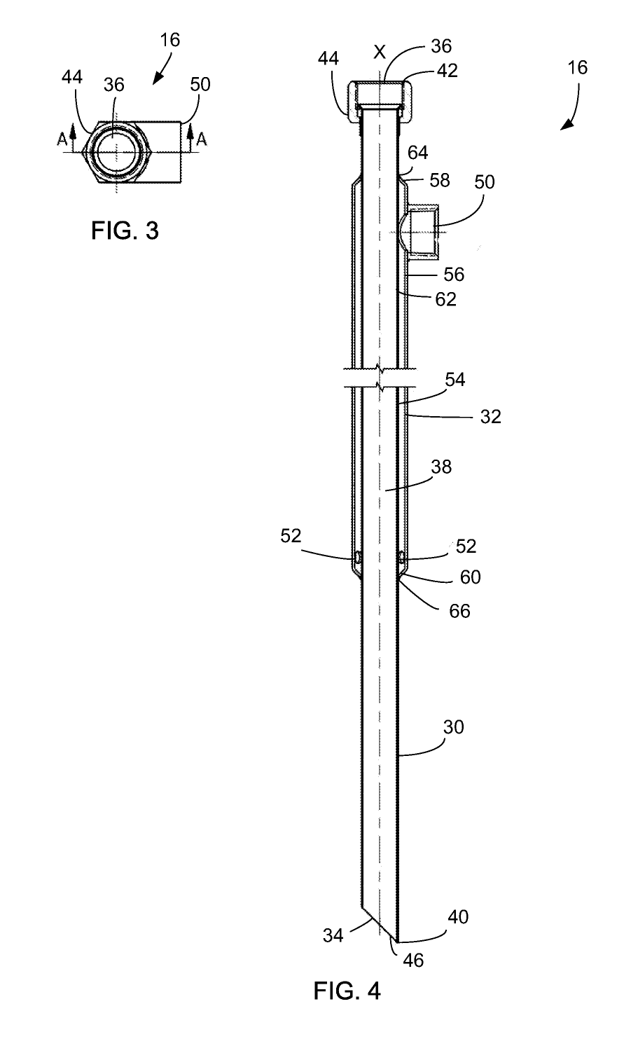

Turning now to FIGS. 2-4, the recirculation device 16 is discussed in detail. The recirculation device 16 is provided to draw hydraulic fluid and water and/or contaminants from the reservoir 12, such as from a bottom of the reservoir and corners of the reservoir 12 where water and/or contaminants gather, and to return the hydraulic fluid and water to the reservoir 12 after the fluid has been processed. To do so the recirculation device 16 includes an inner tube 30 that serves as a suction tube and an outer tube 32 that serves as a return tube. The outer tube 32 at least partially surrounds the inner tube 30, and as shown, the outer tube 32 surrounds the inner tube 30 and is concentric with the inner tube 30.

As best shown in FIG. 4, the inner tube 30 has a suction inlet 34, a suction outlet 36, and a first fluid passage 38 extending therebetween. The suction inlet 34 is provided at a first end 40 of the inner tube 30 for hydraulic fluid and water and/or contaminants from the reservoir 12 to enter the inner tube 30. To reduce pressure drop at the suction inlet 34 and to keep the inlet open, the suction inlet 34 has a face 46 that is offset from an axis X of the inner tube 30, such as at a forty-five degree angle.

The suction outlet 36 is provided at a second end 42 of the inner tube 30 for the hydraulic fluid and water and/or contaminants to exit the inner tube 30 to be filtered. The suction outlet 36 is coupled to an inlet of the pump 18, such as by a fluid conduit, so that the hydraulic fluid and water and/or contaminants may be delivered to the filter 20. The suction outlet 36 may be coupled to the fluid conduit in any suitable manner, such as by threaded connection, such as by coupling a fitting 44 at the second end 42 of the inner tube 30 to a corresponding fitting of the fluid conduit, where an opposite end of the fluid conduit is coupled to the pump 18.

Referring now to the outer tube 32, the outer tube has a return inlet 50, at least one return outlet 52, and in the illustrated embodiment a plurality of return outlets, and a second fluid passage 54 between the inner tube 30 and the outer tube 32. The return inlet 50 is provided in any suitable location along a length of the outer tube 32, such as adjacent a second end 58 of the outer tube 32 so that filtered fluid from the filter 20 can enter the second fluid passage 54. In the illustrated embodiment, the return inlet 50 extends through a wall 56 of the outer tube 32 such that the return inlet is substantially perpendicular to the axis X of the inner tube 30.

The return inlet 50 may be coupled to an outlet of the pump 18 or to an outlet of the filter 20, depending on the location of the filter and pump, such as by a fluid conduit so that the filtered fluid may be delivered to the passage 54 from the pump/filter. The return inlet 50 may be coupled to the fluid conduit in any suitable manner, such as by a threaded connection, and an opposite end of the fluid conduit may be coupled to the outlet of the filter 20 or the outlet of the pump 18.

The plurality of return outlets 52 are provided adjacent a first end 60 of the outer tube 32 for the filtered fluid to exit the second fluid passage 54 into the reservoir 12. By providing the plurality of return outlets 52 near the first end 60 of the outer tube 32, the hydraulic fluid in an area between the first end 60 and the return outlets 52 can drain from the outer tube 32 when not in use rather than pooling in the area. As illustrated, the plurality of return outlets 52 are circumferentially spaced around the outer tube 32 and extend through the wall 56 of the outer tube 32 such that the return outlets 52 are substantially perpendicular to the axis X of the inner tube 30. In this way, the plurality of return outlets 52 direct the fluid exiting the second fluid passage 54 laterally away from the inner tube 30 to prevent direct recirculation, such as immediate recirculation (for example recirculation within approximately one to two seconds), of the fluid from the plurality of the return outlets 52 to the suction inlet 34. Direct recirculation occurs when fluid exiting return outlets, which are immersed in fluid in the reservoir, reenters the suction inlet after being returned to the reservoir instead of allowing unfiltered fluid to be processed first. Preventing direct recirculation prevents a loop of previously filtered fluid from being reprocessed.

When the recirculation device 16 is in use in the reservoir 12 containing fluid in which the plurality of return outlets 52 are immersed, the filtered fluid exiting the plurality of return outlets 52 agitates the fluid in the reservoir 12, thereby agitating the particulates so that the particulates can more easily be directed into the suction inlet 34 to be filtered out of the fluid. The spacing of the plurality of return outlets 52 around the outer tube 32 allows a greater volume of fluid in the reservoir 12 to be agitated to reduce or eliminate static zones of particulates and water in the reservoir 12. Although it is not required for the plurality of return outlets 52 to be immersed by the fluid in the reservoir 12, such immersion prevents splash back in the reservoir 12 and prevents the fluid from being aerated.

The plurality of return outlets 52 may also be spaced from the suction inlet 34 a sufficient distance to prevent, when in use in the reservoir 12 containing fluid in which the plurality of return outlets 52 are immersed, direct recirculation of the fluid from the plurality of the return outlets 52 to the suction inlet 34, and more particularly recirculation of the fluid during a period of approximately thirty seconds, for example, such as fluid flowing at two to eight gallons per minute in a reservoir of at least fifteen gallons. In an embodiment, the period of time is at least thirty seconds, for example at a flow rate of two and a half gallons per minute in a reservoir of at least fifteen gallons.

In an embodiment, the plurality of return outlets 52 may be spaced from the suction inlet 34 a distance at least three times a diameter of the inner tube 30 to prevent direct recirculation of the fluid from the plurality of return outlets 52 to the suction inlet 34. In another embodiment, the plurality of return outlets 52 may be spaced from the suction inlet 34 a distance of at least six times the diameter of the inner tube 30 to prevent recirculation of the fluid during a period of approximately thirty seconds. In still another embodiment, the plurality of return outlets 52 may be spaced from the suction inlet 34 a distance at least twelve times the diameter of the inner tube 30. As the distance between the suction inlet 34 and return outlets 52 increases, the amount of time between fluid recirculation increases, such as greater than thirty seconds, and the amount of mixing between the returned fluid and the fluid in the reservoir increases. Additionally, as the reservoir size and/or fluid flow rate increases, the amount of time between fluid recirculation increases, such as greater than thirty seconds.

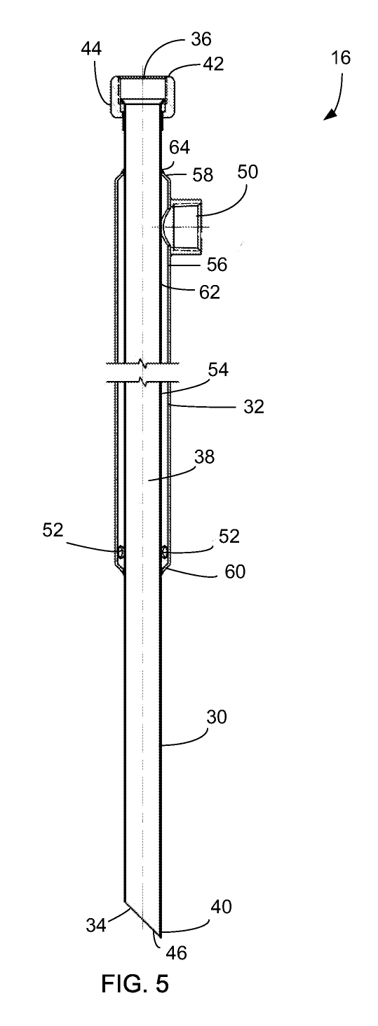

The inner tube 30 and outer tube 32 may be coupled in any suitable manner. For example, the first and second ends 60 and 58 of the outer tube 32 may be coupled to an outer wall 62 of the inner tube 30, such as by welding or brazing at 64 and 66. Alternatively, the inner tube 30 and outer tube 32 may be integrally formed. In another embodiment shown in FIG. 5, the second end 58 of the outer tube 32 may be coupled to the outer wall 62 of the inner tube 30 in any suitable manner, such as by welding or brazing at 64, and the first end 60 of the outer tube 32 may be unconnected from the inner tube 30. In this way, fluid in the second fluid passage 54 between the plurality of return outlets 52 and the first end 60 of the outer tube 32 may be drained from the second fluid passage 54.

During operation of the portable filter cart 10, the recirculation device 16 is introduced into the reservoir 12, such as via a single access port of the reservoir 12 having a small diameter, such as two inches. The recirculation device 16 can be positioned in high contaminant areas in the reservoir 12, such as in a corner or a crack in the bottom of the reservoir 12. Once positioned, the pump 18 may be turned on and suction from the pump 18 causes the recirculation device 16 to draw the hydraulic fluid and water and/or contaminants into the first fluid passage 38 of the inner tube 30 via the suction inlet 34. The fluid travels through the first fluid passage 38 and exits the inner tube 30 via the suction outlet 136, where it travels through the fluid conduit coupled to the inner tube 30 and into the filter 20.

The filter 20 filters the particulates and/or water from the hydraulic fluid and then delivers the filtered fluid to the fluid conduit coupled to the return inlet 50 of the outer tube 32. The filtered fluid flows through the fluid conduit and enters return inlet 50, where the filtered fluid enters the second fluid passage 54. The fluid then travels through the second fluid passage 54 to the plurality of return outlets 52. The filtered fluid exits the plurality of return outlets 52 into the reservoir 12 laterally away from the inner tube 30. The filtered fluid being returned to the reservoir 12 serves to agitate the hydraulic fluid in the reservoir 12 to thereby agitate the remaining water and/or particulates in the reservoir 12, while avoiding direct recirculation of the filtered fluid by the recirculation device 16.

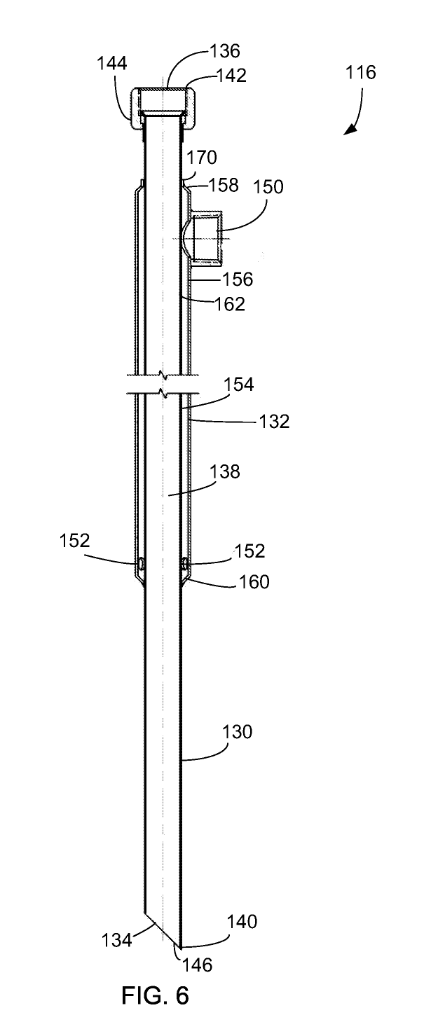

Turning now to FIG. 6, an exemplary embodiment of the recirculation device is shown at 116. The recirculation device 116 is substantially the same as the above-referenced recirculation device 16, and consequently the same reference numerals but indexed by 100 are used to denote structures corresponding to similar structures in the recirculation device. In addition, the foregoing description of the recirculation device 16 is equally applicable to the recirculation device 116 except as noted below. Rather than coupling the outer tube 132 to the inner tube 130 by welding or brazing, the second end 158 of the outer tube 132, which has an inner diameter substantially the same as an outer diameter of the inner tube 130, is sealed to the inner tube 130 by a suitable seal, such as by o-ring 170 provided in a seal groove in the outer tube 132. The o-ring 170 prevents fluid leakage from the second fluid passage 154 at the second end 158, and allows for the seal to be maintained along a length of the inner tube 30. The first end 160 of the outer tube 132 may be either sealed to the inner tube 130 by a suitable seal in a similar manner as the second end 158, or be un-sealed and unconnected from the inner tube 130.

The outer tube 132 may be axially movable relative to the inner tube 130 along a length of the inner tube 130 to adjust the distance between the plurality of return outlets 152 and the suction inlet 146. The distance between the plurality of return outlets 152 and the suction inlet 146 may be adjusted, for example, to compensate for varying fluid depths in the reservoir 12. For example, the outer tube 132 may be moved axially along the length of the inner tube 130 towards the first end 140 of the inner tube 130 when the fluid depth in the reservoir 12 is low to prevent splash back and to prevent the fluid from being aerated. Alternatively, the outer tube 132 may be moved axially towards the second end 142 of the inner tube 130 when the fluid depth in the reservoir 12 is high to prevent direct recirculation for greater periods of time than when the plurality of return outlets 152 are closer to the first end 140 of the inner tube 130.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A recirculation device for recirculating fluid within a system, the device including:
an inner tube having a suction inlet at a first end through which fluid enters the inner tube, a suction outlet at a second end through which fluid exits the inner tube, and a first fluid passage extending therebetween; and
an outer tube at least partially surrounding the inner tube and forming therebetween a second fluid passage, the outer tube including first and second ends, a return inlet through which fluid enters the second fluid passage, and at least one return outlet adjacent the first end of the outer tube through which fluid exits the second fluid passage.

2. The recirculation device according to claim 1, wherein the at least one return outlet directs the fluid in a direction laterally away from the inner tube.

3. The recirculation device according to claim 2, wherein the at least one return outlet includes a plurality of return outlets circumferentially spaced around the outer tube.

4. The recirculation device according to any preceding claim, wherein the return inlet extends through a wall of the outer tube adjacent the second end of the outer tube and the at least one return inlet extends through the wall adjacent the first end of the outer tube.

5. The recirculation device according to any preceding claim, wherein the at least one return outlet is spaced from the suction inlet a sufficient distance to prevent, when in use in a reservoir containing fluid in which the return outlet of the outer tube is immersed, recirculation of the fluid from the return outlet to the suction inlet during a period of approximately thirty seconds.

6. The recirculation device according to any preceding claim, wherein the at least one return outlet is spaced from the suction inlet a distance at least six times the diameter of the inner tube to prevent direct recirculation of the fluid from the return outlet to the suction inlet.

7. The recirculation device according to claim 6, wherein the distance is at least twelve times the diameter of the inner tube.

8. The recirculation device according to any preceding claim, wherein the inner and outer tubes are concentric.

9. The recirculation device according to any preceding claim, wherein the return inlet is adjacent a second end of the outer tube.

10. The recirculation device according to any preceding claim, wherein the outer tube is coupled to the inner tube at the second end of the outer tube by welding or brazing.

11. The recirculation device according to any preceding claim, wherein the outer tube is coupled to the inner tube at the first and second ends by welding or brazing.

12. The recirculation device according to any one of claims 1-9, wherein the outer tube is sealed to the inner tube at the second end.

13. The recirculation device according to claim 12, wherein the outer tube includes a seal disposed in a seal groove in the outer tube to seal the outer tube to the inner tube.

14. The recirculation device according to claim 12 or 13, wherein the outer tube is axially movable relative to the inner tube along a length of the inner tube.

15. The recirculation device according to any preceding claim, wherein the first end has a face that is offset from an axis of the inner tube.

16. The recirculation device according to claim 15, wherein the face is offset at a forty-five degree angle.

17. A recirculation device for recirculating fluid within a system, the device including:
an inner tube having a suction inlet at a first end, a suction outlet at a second end, and a first fluid passage extending therebetween; and
an outer tube surrounding the inner tube and including a return inlet through a wall of the outer tube adjacent a second end of the outer tube and at least one return outlet through the wall adjacent a first end of the outer tube,
wherein a second fluid passage from the return inlet to at least one return outlet is formed between the wall of the outer tube and a wall of the inner tube.

18. The recirculation device according to claim 17, wherein the at least one return outlet directs the fluid in a direction laterally away from the inner tube.

19. The recirculation device according to claim 17 or 18, wherein the at least one return outlet includes a plurality of return outlets circumferentially spaced around the outer tube.

20. The recirculation device according to any one of claims 17-19, wherein the at least one return outlet is spaced from the suction inlet a sufficient distance to prevent, when in use in a reservoir containing fluid in which the return outlet of the outer tube is immersed, recirculation of the fluid from the return outlet to the suction inlet during a period of approximately thirty seconds.

21. The recirculation device according to any one of claims 17-20, wherein the at least one return outlet is spaced from the suction inlet a distance at least six times the diameter of the inner tube to prevent direct recirculation of the fluid from the return outlet to the suction inlet.

22. The recirculation device according to claim 21, wherein the distance is at least twelve times the diameter of the inner tube.

23. The recirculation device according to any one of claims 17-22, wherein the inner and outer tubes are concentric.

24. The recirculation device according to any one of claims 17-23, wherein the outer tube is coupled to the inner tube at the second end of the outer tube by welding or brazing.

25. The recirculation device according to any one of claims 17-24, wherein the outer tube is coupled to the inner tube at the first and second ends by welding or brazing.

26. The recirculation device according to any one of claims 17-23, wherein the outer tube is sealed to the inner tube at the second end.

27. The recirculation device according to claim 26, wherein the outer tube includes a seal disposed in a seal groove in the outer tube to seal the outer tube to the inner tube.

28. The recirculation device according to claim 26 or 27, wherein the outer tube is axially movable relative to the inner tube along a length of the inner tube.

29. The recirculation device according to any one of claims 17-28, wherein the first end has a face that is offset from an axis of the inner tube.

30. The recirculation device according to claim 29, wherein the face is offset at a forty-five degree angle.

31. A portable filter cart including:
a recirculation wand including:
an inner tube having a suction inlet at a first end through which fluid enters the inner tube, a suction outlet at a second end through which fluid exits the inner tube, and a first fluid passage extending therebetween; and
an outer tube at least partially surrounding the inner tube and forming therebetween a second fluid passage, the outer tube including first and second ends, a return inlet through which fluid enters the second fluid passage, and at least one return outlet adjacent the first end of the outer tube through which fluid exits the second fluid passage; and
a pump having an inlet coupled to the suction outlet and an outlet coupled to the return inlet.

32. The portable filter cart according to claim 31, further including a filter coupled to one of inlet or outlet of the pump for removing contaminants from the fluid.

33. The portable filter cart according to claim 31 or 32, wherein the inner and outer tubes are concentric.

34. A method of filtering hydraulic fluid in a reservoir, the method including:
drawing fluid into an inner tube of a recirculation wand;
delivering the fluid from the inner tube to a filter;
filtering contaminants from the fluid;
delivering the fluid from the filter to a flow path between the inner tube and an outer tube of the recirculation wand surrounding the inner tube; and
directing the fluid from the flow path into the reservoir in a direction laterally away from the inner tube.
